(19) United States
(12) Patent Application Publication
(10) Pub. No.: US 2017/0093959 A1
(43) Pub. Date: Mar. 30, 2017

(54) METHOD, INFORMATION PROCESSING APPARATUS, AND STORAGE MEDIUM

(71) Applicant: FUJITSU LIMITED, Kawasaki-shi (JP)

(72) Inventors: Ryoichi Funabashi, Kawasaki (JP); RYUTA TANAKA, Machida (JP)

(73) Assignee: FUJITSU LIMITED, Kawasaki-shi (JP)

(21) Appl. No.: 15/269,293

(22) Filed: Sep. 19, 2016

(30) Foreign Application Priority Data
Sep. 30, 2015 (JP) 2015-194436

(51) Int. Cl. H04L 29/08

(52) U.S. Cl. CPC H04L 67/10; H04L 67/18

(57) ABSTRACT

A method executed by an information processing apparatus, the method includes: in response to a data transmission request from a first mobile terminal capable of performing first wireless communication and second wireless communication different from the first wireless communication, identifying a second mobile terminal that is predicted to be located near the first mobile terminal based on location management information, the second mobile terminal being capable of performing the second wireless communication and third wireless communication different from the first wireless communication; transmitting data corresponding to the data transmission request to the identified second mobile terminal through the third wireless communication; and instructing the second mobile terminal to, when the second mobile terminal receives the data, transfer the received data to the first mobile terminal through the second wireless communication.

### CROSS-REFERENCE TO RELATED APPLICATION

This application is based upon and claims the benefit of priority of the prior Japanese Patent Application No. 2015-194436, filed on Sep. 30, 2015, the entire contents of which are incorporated herein by reference.

### FIELD

The embodiments discussed herein are related to a method, an information processing apparatus, and a storage medium.

### BACKGROUND

There is known a technique in which, when the communication rate is slow in communication over a mobile network, a unit of data is downloaded by each of a plurality of mobile terminals, and a plurality of units of data downloaded are combined together. The plurality of units of data downloaded are combined together through ad-hoc communication. With this technique, a plurality of units of data are downloaded by a plurality of mobile terminals, respectively, and thus the time taken for downloading to be complete is reduced even for the case where downloading is performed over a mobile network having a low communication rate.

Japanese Laid-open Patent Publication No. 2009-064104 is known as an example of related art.

### SUMMARY

According to an aspect of the invention, a method executed by an information processing apparatus, the method includes: in response to a data transmission request from a first mobile terminal capable of performing first wireless communication and second wireless communication different from the first wireless communication, identifying a second mobile terminal that is predicted to be located near the first mobile terminal based on location management information, the second mobile terminal being capable of performing the second wireless communication and third wireless communication different from the first wireless communication; transmitting data corresponding to the data transmission request to the identified second mobile terminal through the third wireless communication; and instructing the second mobile terminal to, when the second mobile terminal receives the data, transfer the received data to the first mobile terminal through the second wireless communication.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A illustrates an example of main unit functionality of a server;

FIG. 1B illustrates an example of main unit functionality of a mobile terminal;

FIG. 2A illustrates an example of hardware of the server;

FIG. 2B illustrates an example of hardware of the mobile terminal;

FIG. 3 is a conceptual diagram for explaining an example of data communication control according to a first embodiment;

FIG. 4 is a flowchart illustrating an example of a flow of a data communication control process according to the first embodiment;

FIG. 5 depicts an example of a mobile-terminal location information table;

FIG. 6 is a conceptual diagram for explaining an example of data communication control according to a second embodiment;

FIG. 7 is a flowchart illustrating an example of a flow of a data communication control process according to the second embodiment;

FIG. 8 is a conceptual diagram for explaining an example of data communication control according to a third embodiment;

FIG. 9 is a flowchart illustrating an example of a flow of a data communication control process according to the third embodiment;

FIG. 10 is a conceptual diagram for explaining an example of data communication control according to a fourth embodiment; and

FIG. 11 is a flowchart illustrating an example of a flow of a data communication control process according to the fourth embodiment.

### DESCRIPTION OF EMBODIMENTS

When some area is crowded with a plurality of mobile terminals, the communication rate of a mobile network in this area is slower. This makes it difficult to reduce the time taken for downloading to be complete, even if the above technique of related art is used. Additionally, when communication of a mobile network in this area is interrupted, it is not possible to perform downloading even if the above technique of related art is used.

In one aspect, embodiments of the present disclosure enable data to be efficiently transmitted from an information processing apparatus to a mobile terminal when the communication rate is decreased in communication between the information processing apparatus and the mobile terminal or when the communication is interrupted.

### First Embodiment

Hereinafter, a first embodiment, an example of the embodiments, will be described in detail with reference to the accompanying drawings.

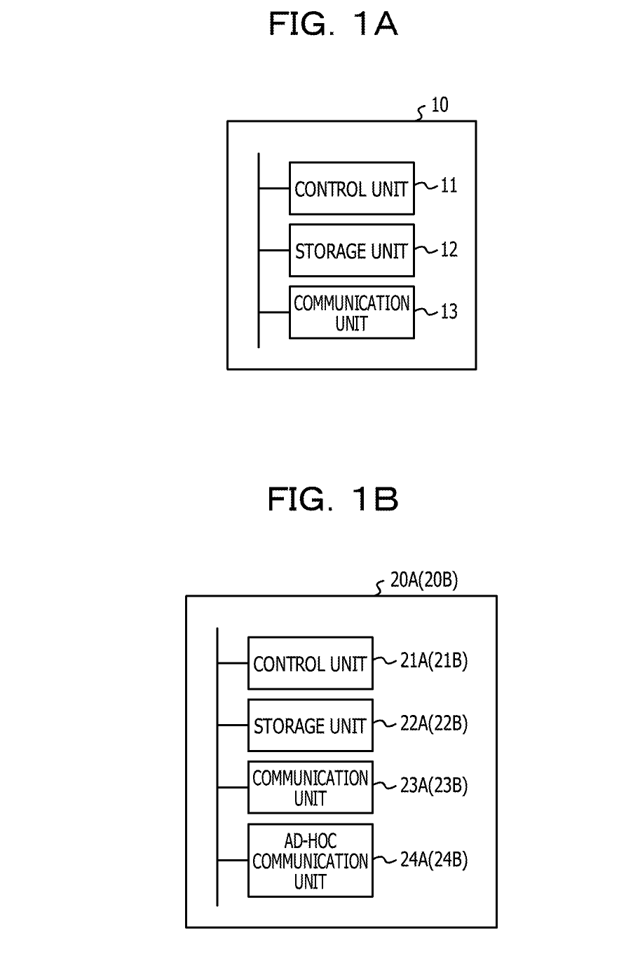

FIG. 1A illustrates an example of main unit functionality of a server. A server 10, which is an example of an information processing apparatus illustrated in FIG. 1A, includes a control unit 11, a storage unit 12, and a communication unit 13. The communication unit 13 receives a data transmission request from a first mobile terminal described below through cellular telephone communication serving as an example of first wireless communication or third wireless communication, and transmits data corresponding to the data transmission request.

The control unit 11 performs control so as to transmit the data corresponding to the data transmission request to a second mobile terminal described below via the communication unit 13. The second mobile terminal is movable. When the second mobile terminal moves into an area where communication is possible through cellular telephone communication, the second mobile terminal performs communication with the server 10 and receives data from the server 10 through the cellular telephone communication serving as an example of the third wireless communication. Additionally, when the second mobile terminal moves into an area where communication is possible through ad-hoc communication serving as an example of second wireless communication, the second terminal performs communication with the first mobile terminal. After the second mobile terminal has moved to an area where communication with the first mobile terminal is possible through ad-hoc communication, the control unit 11 instructs the second mobile terminal to transmit data from the second mobile terminal to the first mobile terminal through the ad-hoc communication.

The ad-hoc communication is, for example, a short-range wireless communication network such as Bluetooth (registered trademark), infrared data association (IrDA), or Wi-Fi (registered trademark). The server 10 may be, for example, but not limited to, a workstation, a desktop computer, or a notebook computer.

FIG. 1B illustrates main unit functionality of a mobile terminal. A mobile terminal 20A illustrated in FIG. 1B, which is an example of the first mobile terminal (the mobile terminal 20A is hereinafter also called a first mobile terminal 20A), includes a control unit 21A, a storage unit 22A, a communication unit 23A, and an ad-hoc communication unit 24A. The communication unit 23A performs communication operations when the control unit 21A transmits and receives data through the cellular telephone communication serving as an example of the first wireless communication. The ad-hoc communication unit 24A performs communication operations when the control unit 21A transmits and receives data through ad-hoc communication.

The configurations of the mobile terminal 20A and the mobile terminal 20B are similar, and thus the configuration of the mobile terminal 20B is not described herein. The mobile terminal 20A and the mobile terminal 20B are also called mobile terminals 20 when they do not have to be particularly discriminated from each other. The mobile terminal 20 may be, for example, but not limited to, a portable phone, a smart phone, a tablet computer, or the like.

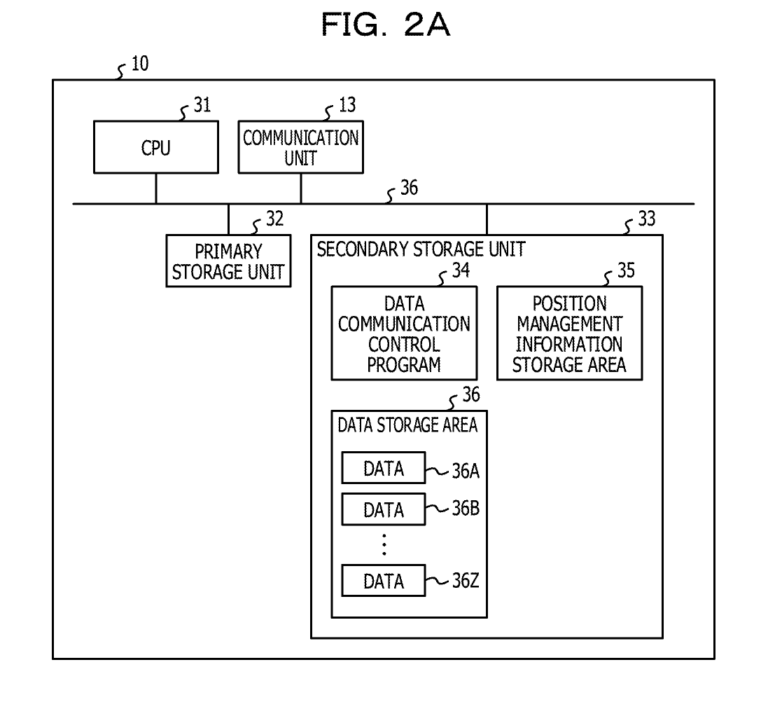

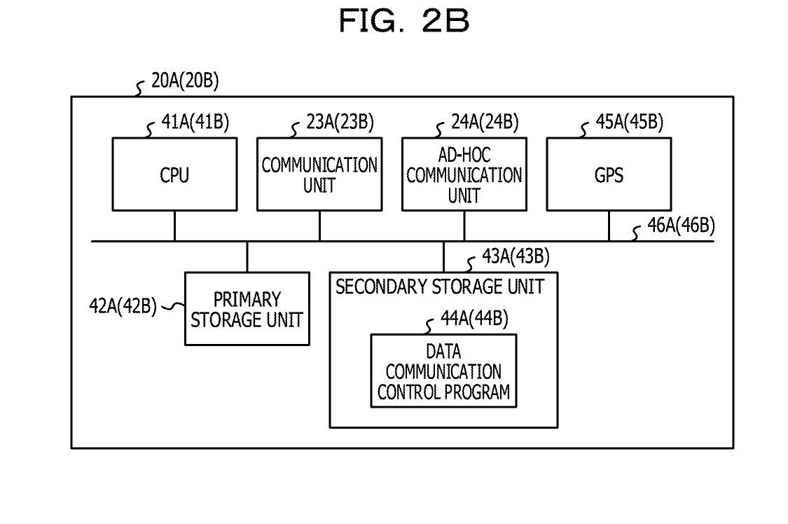

FIG. 2A illustrates an example of hardware of a server. The server 10 includes, by way of example, as illustrated in FIG. 2A, a central processing unit (CPU) 31, which is an example of a processor, a primary storage unit 32, a secondary storage unit 33, and a communication unit 13. The CPU 31, the primary storage unit 32, the secondary storage unit 33, and the communication unit 13 are coupled to one another via a bus 36.

The primary storage unit 32 and the secondary storage unit 33 are examples of the storage unit 12 in FIG. 1A. The primary storage unit 32 is, for example, volatile memory such as random access memory (RAM). The secondary storage unit 33 is, for example, nonvolatile memory such as a hard disk drive (HDD) or a solid state drive (SSD).

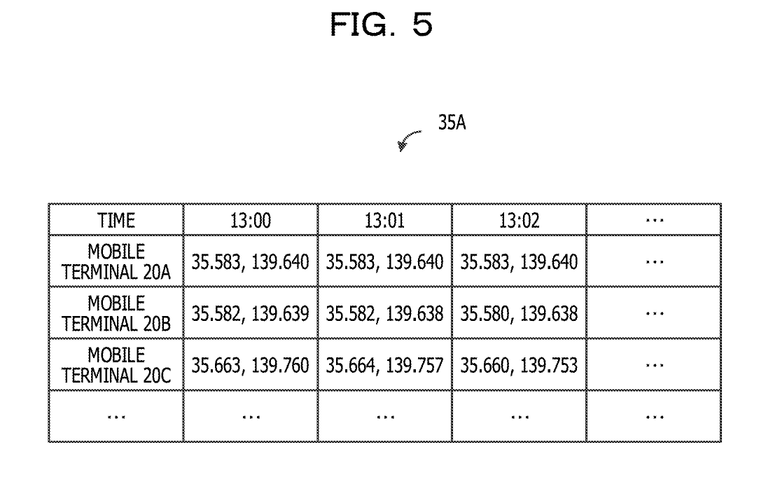

The secondary storage unit 33 stores, by way of example, a data communication control program 34. The secondary storage unit 33 also includes a data storage area 36 for storing data 36A, 36B, . . . , 36Z including data that is requested to be transmitted from the mobile terminal 20A. The secondary storage unit 33 also includes a location management information storage area 35 for storing information that is included in a mobile-terminal location information table 35A, which is an example of location management information an example of which is depicted in FIG. 5.

FIG. 5 depicts an example of a mobile-terminal location information table. By way of example, the mobile-terminal location information table 35A is a table in which the latitude and longitude of the mobile terminals 20 are recorded with respect to time. For example, the mobile terminal 20A at 1 p.m. (13:00) is at a latitude of 35.583 and a longitude of 139.640. In this example, the location information per minute of each mobile terminal is registered in the mobile-terminal location information table 35A. Note that the data storage area 36 and the location management information storage area 35 may be included in an external device, not in the server 10. In this case, the CPU 31 acquires the data 36A, 36B, . . . , 36Z and the location information of a mobile terminal, for example, via the communication unit 13.

The CPU 31 reads the data communication control program 34 from the secondary storage unit 33 and loads it onto the primary storage unit 32. The CPU 31 executes the data communication control program 34 to operate as the control unit 11 illustrated in FIG. 1A.

FIG. 2B illustrates an example of hardware of the mobile terminal. The mobile terminal 20A includes, by way of example, as illustrated in FIG. 2B, a CPU 41A, a primary storage unit 42A, a secondary storage unit 43A, the communication unit 23A, the ad-hoc communication unit 24A, and a global positioning system (GPS) 45A. The CPU 41A, the primary storage unit 42A, the secondary storage unit 43A, the communication unit 23A, the ad-hoc communication unit 24A, and the GPS 45A are coupled to one another via a bus 46A.

The primary storage unit 42A and the secondary storage unit 43A are examples of the storage unit 22A illustrated in FIG. 1B. The primary storage unit 42A is, for example, volatile memory such as RAM. The secondary storage unit 43A is, for example, nonvolatile memory such as an HDD or an SSD. The secondary storage unit 43A stores, by way of example, a data communication control program 44A.

The CPU 41A reads the data communication control program 44A from the secondary storage unit 43A and loads it onto the primary storage unit 42A. The CPU 41A executes the data communication control program 44A to operate as the control unit 21A illustrated in FIG. 1B. The GPS 45A acquires location information indicating the location of the mobile terminal 20A. The configurations of the mobile terminal 20A and the mobile terminal 20B are similar, and thus the configuration of the mobile terminal 20B is not described herein. Note that, the reference numeral of each component of the mobile terminal 20B is accompanied with B in place of A.

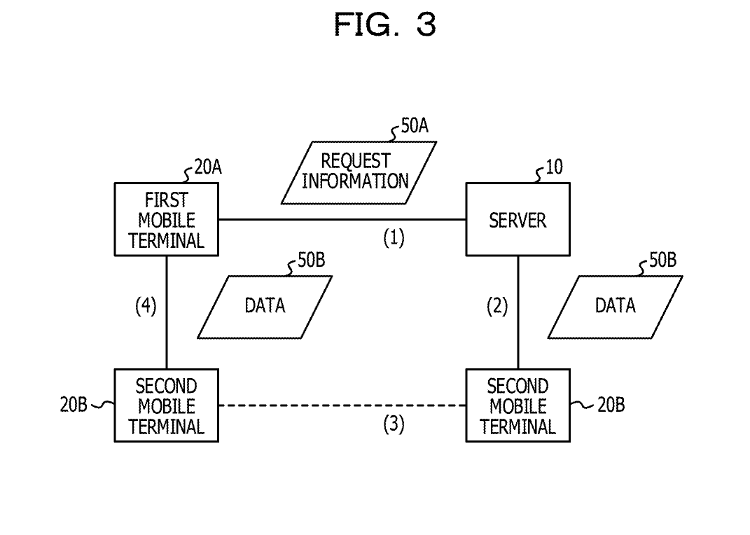

Next, the outline of operations of the server 10, the mobile terminal 20A, and the mobile terminal 20B, which constitute an example of a data communication control system, will be described. FIG. 3 is a conceptual diagram for explaining an example of data communication control according to the first embodiment. In the present embodiment, as illustrated in FIG. 3, the server 10 transmits data 50B to the first mobile terminal 20A. Additionally, a large number of mobile terminals 20 that perform communication through the cellular telephone communication are present around the first mobile terminal 20A. That is, the cellular telephone communication, which is an example of the first wireless communication, is congested, and thus the communication performed via the cellular telephone communication has a low communication rate. As a result, it takes a long time to complete transmission of the data 50B from the server 10 to the first mobile terminal 20A, compared with the case where the cellular telephone communication is not congested.

In the present embodiment, as indicated by a solid line (1), the first mobile terminal 20A transmits request information 50A, which is an example of a data transmission request for requesting transmission of the data 50B, to the server 10 through the cellular telephone communication. Having received the request information 50A, the server 10 transmits the data 50B through the cellular telephone communication serving as an example of the third wireless communication, to the mobile terminal 20B, which is an example of the second mobile terminal (the mobile terminal 20B is hereinafter also called a second mobile terminal 20B), as indicated by a solid line (2). Having received the data 50B, the mobile terminal 20B stores the received data 50B. Then, as indicted by a broken line (3), upon moving to an area where communication with the first mobile terminal 20A is possible through ad-hoc communication, as indicated by a solid line (4), the mobile terminal 20B transmits the data 50B to the first mobile terminal 20A through the ad-hoc communication.

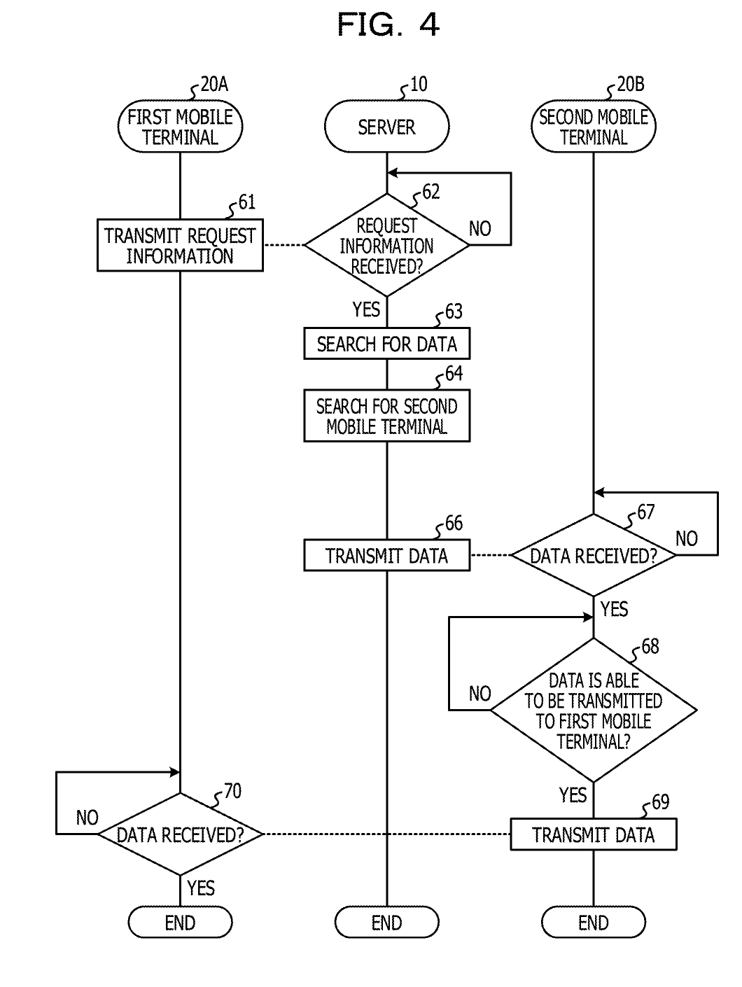

FIG. 4 is a flowchart illustrating an example of a flow of a data communication control process according to the first embodiment. As illustrated in FIG. 4, in step 61, the CPU 41A of the first mobile terminal 20A transmits the request information 50A and the location information of the first mobile terminal 20A through the communication unit 23A to the server 10. Note that the data size of the request information 50A is smaller than the data size of the data 50B. Accordingly, even when cellular telephone communication is congested in an area where the first mobile terminal 20A is located, it is possible to transmit the request information 50A in a relatively short time. The CPU 31 of the server 10, in step 62, determines whether or not the request information 50A and the location information are received via the communication unit 13 and repeats step 62 until an affirmative determination is obtained.

Note that transmission and receipt of information such as the request information 50A and the data 50B may be started by the transmitter issuing a receipt request to the receiver or by the receiver issuing a transmission request to the transmitter. This applies similarly to transmission and receipt of information in the description given below.

If the determination in step 62 is affirmative, then, in step 63, the CPU 31 searches for the data 50B requested with the request information 50A from among the data 36A, 36B, . . . , 36Z of the data storage area 36 of the secondary storage unit 33. Next, in step 64, the CPU 31 searches for the second mobile terminal. In this example, the mobile terminal 20B is searched for as the second mobile terminal.

The condition under which a mobile terminal is the second mobile terminal is that the mobile terminal be predicted to move from an area where communication with the server 10 is possible through cellular telephone communication, which is an example of the third wireless communication, to an area where communication with the first mobile terminal 20A is possible through ad-hoc communication. The area where communication with the server 10 is possible through cellular telephone communication is an area where communication with the server 10 is possible through cellular telephone communication at or above a given rate. Whether or not the mobile terminal 20 is present in the area, where communication is possible through cellular telephone communication, is determined by measuring the time taken until the server 10 receives a test data receipt notification from the mobile terminal 20 after transmitting a small amount of test data to the mobile terminal 20.

Additionally, the destination of movement of the mobile terminal 20 is predicted, for example, from the mobile terminal location information table 35A. The destination of movement of the mobile terminal 20 may be predicted from movement destination information or path information, which is an example of location management information and which is set in a navigation system utilizing the GPS 45 of the mobile terminal 20. The destination of movement of the mobile terminal 20 may also be predicted from schedule information, which is an example of location management information and which is stored in the secondary storage unit 43A of the mobile terminal 20. The destination of movement of the mobile terminal 20 may also be predicted from the past movement history of the mobile terminal 20, which is an example of location management information (for example, starting from the head office at 2 p.m. every Wednesday and arriving at a branch office at 3 p.m.).

That is, based on the predicted movement destination of the mobile terminal 20 and the location information of the first mobile terminal 20A received in step 62, it is determined whether or not the mobile terminal 20 moves to an area where communication with the first mobile terminal 20A is possible through ad-hoc communication. When the mobile terminal 20 is located near the first mobile terminal 20A, the mobile terminal 20 and the first mobile terminal 20A are able to communicate with each other through ad-hoc communication.

In step 66, the CPU 31 of the server 10 transmits the data 50B, the location information of the first mobile terminal 20A, and an instruction for transferring the data 50B to the first mobile terminal 20A, to the second mobile terminal 20B via the communication unit 13, and then completes the data communication control process of the server 10. In step 67, a CPU 41B of the second mobile terminal 20B determines whether or not the data 50B is received via the communication unit 23B, and repeats step 67 until an affirmative determination is obtained in step 67. If the determination in step 67 is affirmative, then, in step 68, the CPU 41B determines whether or not the data 50B is able to be transmitted to the first mobile terminal 20A via the ad-hoc communication unit 24B, and repeats step 68 until an affirmative determination is obtained.

Whether or not the data 50B is able to be transmitted to the first mobile terminal 20A via the ad-hoc communication unit 24B may be determined based on the location information of the first mobile terminal 20A and the location information of the second mobile terminal 20B received in step 67. The location information of the second mobile terminal 20B is acquired by a GPS 45B. That is, by determining whether or not the second mobile terminal 20B is located near the first mobile terminal 20A, it may be determined whether or not the data 50B is able to be transmitted to the first mobile terminal 20A via the ad-hoc communication unit 24B. Whether or not the data 50B is able to be transmitted to the first mobile terminal 20A via the ad-hoc communication unit 24B may be determined as follows. That is, the CPU 41B of the second mobile terminal 20B transmits a small amount of test data to the first mobile terminal 20A via the ad-hoc communication unit 24B, and determines whether or not a test data receipt notification from the first mobile terminal 20A is received by the ad-hoc communication unit 24B.

If the determination in step 68 is affirmative, then, in step 69, the CPU 41B transmits the data 50B to the first mobile terminal 20A via the ad-hoc communication unit 24B and then completes the data communication control process of the mobile terminal 20B.

On the other hand, in step 70, the CPU 41A of the first mobile terminal 20A determines whether or not the data 50B is received via the ad-hoc communication unit 24A, and repeats step 70 until an affirmative determination is obtained. If the determination in step 70 is affirmative, the CPU 41A completes the data communication control process of the first mobile terminal 20A.

Note that if, in step 63, a plurality of mobile terminals 20 are searched for as second mobile terminal candidates, a mobile terminal 20 with which the time T taken for the data 50B to be transmitted to the first mobile terminal 20A is shortest among the plurality of mobile terminals 20 may be selected as the second mobile terminal. The time T is obtained, for example, by T1+T2+T3. The time T1 is the time taken for the server 10 to transmit the data 50B to a second mobile terminal candidate through cellular telephone communication, and the time T2 is the time taken for the second mobile terminal candidate to move to an area where communication with the first mobile terminal 20A is possible through ad-hoc communication. The time T3 is the time taken for the second mobile terminal candidate to transmit the data 50B to the first mobile terminal 20A through ad-hoc communication.

When, at the time of searching for the mobile terminal 20 serving as a second mobile terminal candidate, no second mobile terminal candidate is located in an area where communication with the server 10 is possible through cellular telephone communication, the time T is obtained by T1+T2+T3+T4. The time T4 is the time taken for the second mobile terminal candidate to move to an area where communication with the server 10 is possible through cellular telephone communication. In addition, the time T may be the time taken for movement of the second mobile terminal candidate, that is, T2 or T2+T4.

Note that the time T1 is obtained, for example, by (DA/TDA)×TT1. DA is the data size of the data 50B, TDA is the data size of test data, and TT1 is the time taken for transmission measured when the server 10 transmits the test data to the second mobile terminal candidate. The time T3 is obtained, for example, by DA/ANV. ANV is a standard communication rate in ad-hoc communication.

The time T2 is obtained, for example, by acquiring, from the mobile terminal location information table 35A, the time at which the second mobile terminal candidate arrives at a location indicated by the location information of the first mobile terminal 20A. The time T4 is obtained, for example, by acquiring, from the mobile terminal location information table 35A, the time at which the second mobile terminal candidate arrives at an area where the second mobile terminal candidate and the server 10 are able to communicate through cellular telephone communication. The time T2 and the time T4 may be obtained from the movement destination information or path information set in a navigation system utilizing the GPS 45 of the second movement terminal candidate, or may be obtained from schedule information stored in the secondary storage unit 43A of the secondary mobile terminal candidate. The time T2 and the time T4 may be obtained from the past movement history of the second mobile terminal candidate.

The data 50B is divided into pieces, and a plurality of mobile terminals 20 searched for as the second mobile terminal candidates may transmit the divided pieces of the data 50B to the first mobile terminal 20A, respectively.

Note that when, in step 64, the second mobile terminal is searched for, the second terminal 20 serving as a second mobile terminal candidate may be selected as the second mobile terminal 20B if the data size that this second terminal 20 is capable of transmitting to the first mobile terminal 20A is larger than or equal to the data size of the data 50B. That is, if the mobile terminal 20 is located near the first mobile terminal 20A from the start of transmission of the data 50B to completion of the transmission, the mobile terminal 20 is selected as the second mobile terminal 20B. For example, a second mobile terminal candidate that satisfies DA/ANV≦ST is selected as the mobile terminal 20. ST is the time over which the second mobile terminal candidate stays near the first mobile terminal 20A.

Note that the data communication control process in FIG. 4 is started if the time TT2 taken for transmission, which is measured when the CPU 31 of the server 10 transmits a small amount of test data to the first mobile terminal 20A, is greater than or equal to a given period of time. That is, transmission of the request information 50A in step 61 is performed when communication between the server 10 and the first mobile terminal 20A performed via cellular telephone communication has a communication rate lower than or equal to a given rate. If the communication rate of the communication performed via cellular telephone communication is not lower than or equal to the given rate, the CPU 31 of the server 10 directly transmits the data 50B to the first mobile terminal 20A through cellular telephone communication.

Note that the first mobile terminal 20A may move after transmitting the request information 50A to the server 10 in step 61. Even if the first mobile terminal 20A moves, the mobile terminal 20B acquires location information of the first mobile terminal 20A, for example, from the mobile terminal location information table 35A.

In the present embodiment, the server 10 identifies the second mobile terminal 20B in response to the request information 50B from the first mobile terminal 20A that is capable of performing cellular telephone communication and ad-hoc communication. The second mobile terminal 20B is a mobile terminal that is predicted to be located near the first mobile terminal 20A based on the location information of the mobile terminal 20 and that is capable of performing cellular telephone communication and ad-hoc communication. The server 10 transmits the data 50B corresponding to the request information 50A to the second mobile terminal 20B through cellular telephone communication that allows communication with the second mobile terminal 20B to be performed at or above a given rate. Additionally, the server 10 instructs the second mobile terminal 20B that, when the second mobile terminal 20B receives the data 50B, the second mobile terminal 20B transfer the received data 50B to the first mobile terminal 20A through ad-hoc communication.

As described above, in the present embodiment, when communication between the server 10 and the first mobile terminal 20A has a decreased communication rate, data is efficiently transmitted from the server 10 to the first mobile terminal 20A.

### Second Embodiment

Next, a second embodiment, an example of the embodiments, will be described. The configurations and operations similar to those in the first embodiment are not described herein. First, the outline of operations of the server 10, the mobile terminal 20A, a mobile terminal 20C, and a mobile terminal 20D, which constitute an example of a data communication control system, will be described. Note that the configurations of the mobile terminal 20C and the mobile terminal 20D are each similar to the configuration of the mobile terminal 20A, and the reference numerals of components of the mobile terminal 20C and the mobile terminal 20D are accompanied with C and D, respectively, in place of A.

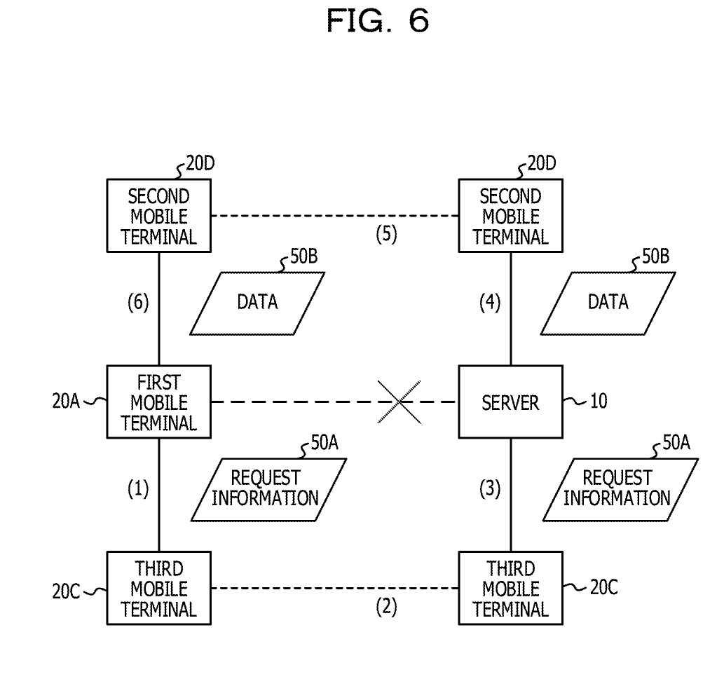

FIG. 6 is a conceptual diagram for explaining an example of data communication control according to the second embodiment. In the present embodiment, as illustrated in FIG. 6, the server 10 transmits the data 50B to the first mobile terminal 20A. Unlike the first embodiment, communication between the server 10 and the first mobile terminal 20A performed via cellular telephone communication is interrupted. Consequently, the first mobile terminal 20A is not able to transmit the request information 50A to the server 10 through cellular telephone communication.

In the present embodiment, as indicated by a solid line (1), the first mobile terminal 20A transmits the request information 50A for requesting the data 50B, to the mobile terminal 20C, which is an example of the third mobile terminal (the mobile terminal 20C is hereinafter also called a third mobile terminal 20C), through ad-hoc communication. As indicated by a broken line (2), upon moving to an area where communication with the server 10 is possible through cellular telephone communication, as indicated by a solid line (3), the third mobile terminal 20C transmits the request information 50A to the server 10 through cellular telephone communication. Having received the request information 50A, as indicated by a solid line (4), the server 10 transmits the data 50B to the mobile terminal 20D, which is an example of the second mobile terminal (the mobile terminal 20D is hereinafter also called a second mobile terminal 20D).

As indicated by a broken line (5), upon moving to an area where communication with the first mobile terminal 20A is possible through ad-hoc communication, as indicated by a solid line (6), the mobile terminal 20D transmits the data 50B to the first mobile terminal 20A through ad-hoc communication.

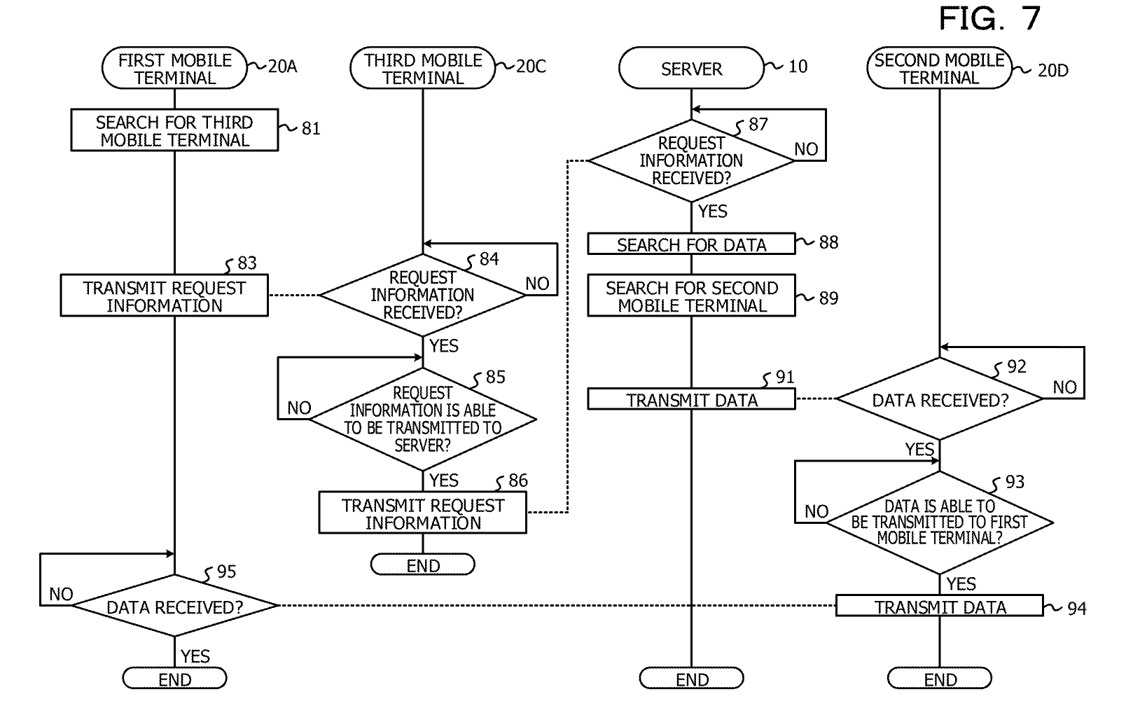

FIG. 7 is a flowchart illustrating an example of a flow of a data communication control process according to the second embodiment. As illustrated in FIG. 7, in step 81, the CPU 41A of the first mobile terminal 20A searches for a third mobile terminal. The condition under which a mobile terminal is the third mobile terminal is that the mobile terminal move from an area where communication with the first mobile terminal 20A is possible through ad-hoc communication to an area where communication with the server 10 is possible through cellular telephone communication. The method described regarding search for the second mobile terminal in the first embodiment is applicable to search for the third mobile terminal, and therefore the search for the third mobile terminal is not described in detail here. In this example, the mobile terminal 20C is searched for as the third mobile terminal.

In step 83, the CPU 41A of the first mobile terminal 20A transmits the request information 50A for requesting the data 50B and the location information of the first mobile terminal 20A to the third mobile terminal 20C via the ad-hoc communication unit 24A. In step 84, the CPU 41C of the third mobile terminal 20C determines whether or not the request information 50A and the location information are received via the ad-hoc communication unit 24C and repeats step 84 until an affirmative determination is obtained.

If the determination in step 84 is affirmative, then, in step 85, the CPU 41C determines whether or not the request information 50A and the location information are able to be transmitted to the server 10. That is, the CPU 41C determines whether or not the third mobile terminal 20C has moved to an area where the communication with the server 10 is possible through cellular telephone communication, and repeats step 85 until an affirmative determination is obtained.

If the determination in step 85 is affirmative, then, in step 86, the CPU 41C transmits the request information 50A and the location information via the communication unit 23C to the server 10, and completes the data communication control process. In step 87, the CPU 31 of the server 10 determines whether or not the request information 50A and the location information are received and repeats step 87 until an affirmative determination is obtained.

If the determination in step 87 is affirmative, then, in step 88, the CPU 31 searches for the data 50B requested with the request information 50A from among the data 36A, 36B, . . . , 36Z of the data storage area 36 of the secondary storage unit 33. Next, in step 89, the CPU 31 searches for the second mobile terminal.

The condition under which a mobile terminal is the second mobile terminal is that the mobile terminal be predicted to move from an area where communication with the server 10 is possible through cellular telephone communication serving as an example of the third wireless communication, to an area where communication with the first mobile terminal 20A is possible through ad-hoc communication. The area where communication with the server 10 is possible through cellular telephone communication is an area where communication with the server 10 is possible at or above a given rate through cellular telephone communication. Whether or not the mobile terminal 20 is present in the area where communication is possible through cellular telephone communication is determined, for example, by measuring the time taken after the server 10 transmits a small amount of test data to the mobile terminal 20 until the server 10 receives a test data receipt notification from the mobile terminal 20.

In this example, the mobile terminal 20D is searched for as the second mobile terminal. In step 91, the CPU 31 transmits the data 50B, the location information of the first mobile terminal 20A, and an instruction for transferring the data 50B to the first mobile terminal 20A, to the second mobile terminal 20D via the communication unit 13, and completes the data communication control process of the server 10. In step 92, the CPU 41D of the second mobile terminal 20D determines whether or not the data 50B is received via the communication unit 23D from the server 10 and repeats step 92 until an affirmative determination is obtained.

If the determination in step 92 is affirmative, then, in step 93, the CPU 41D determines whether or not the data 50B is able to be transmitted to the first mobile terminal 20A. That is, the CPU 41D determines whether or not the mobile terminal 20D has moved to an area where communication with the first mobile terminal 20A is possible through ad-hoc communication. Step 93 is repeated until an affirmative determination is obtained, and, if the determination is affirmative, the CPU 41D transmits the data 50B to the first mobile terminal 20A via the ad-hoc communication unit 24D and completes the data communication control process.

In step 95, the CPU 41A of the first mobile terminal 20A determines whether or not the data 50B is received via the ad-hoc communication unit 24A and repeats step 95 until an affirmative determination is obtained. If the determination is affirmative, the CPU 41A completes the data communication control process.

In the present embodiment, the server 10 identifies the second mobile terminal 20D in response to the request information 50B from the first mobile terminal 20A that is capable of performing cellular telephone communication and ad-hoc communication. The second mobile terminal 20D is a mobile terminal that is predicted to be located near the first mobile terminal 20A based on the location information of the mobile terminal 20 and that is capable of performing cellular telephone communication and ad-hoc communication. The server 10 transmits the data 50B corresponding to the request information 50A to the second mobile terminal 20D through cellular telephone communication that allows communication with the second mobile terminal 20D to be performed at or above a given rate. Additionally, the server 10 instructs the second mobile terminal 20D that, when the second mobile terminal 20D receives the data 50B, the second mobile terminal 20D transfer the received data 50B to the first mobile terminal 20A through ad-hoc communication.

Additionally, the server 10 receives, through cellular telephone communication, the request information 50A received from the first mobile terminal 20A through ad-hoc communication by the third mobile terminal 20C. The third mobile terminal 20C is capable of performing cellular telephone communication, through which communication with the server 10 is possible, and is capable of performing ad-hoc communication.

As described above, when communication between the server 10 and the first mobile terminal 20A performed via cellular telephone communication is interrupted, data is efficiently transmitted from the server 10 to the first mobile terminal 20A.

### Third Embodiment

Next, a third embodiment, an example of the embodiments, will be described. The configurations and operations similar to those in the first embodiment or the second embodiment are not described herein. Note that the configuration of the mobile terminal 20E is similar to that of the mobile terminal 20A or the mobile terminal 20B, and the reference numerals of components of the mobile terminal 20E are accompanied with E in place of A or B.

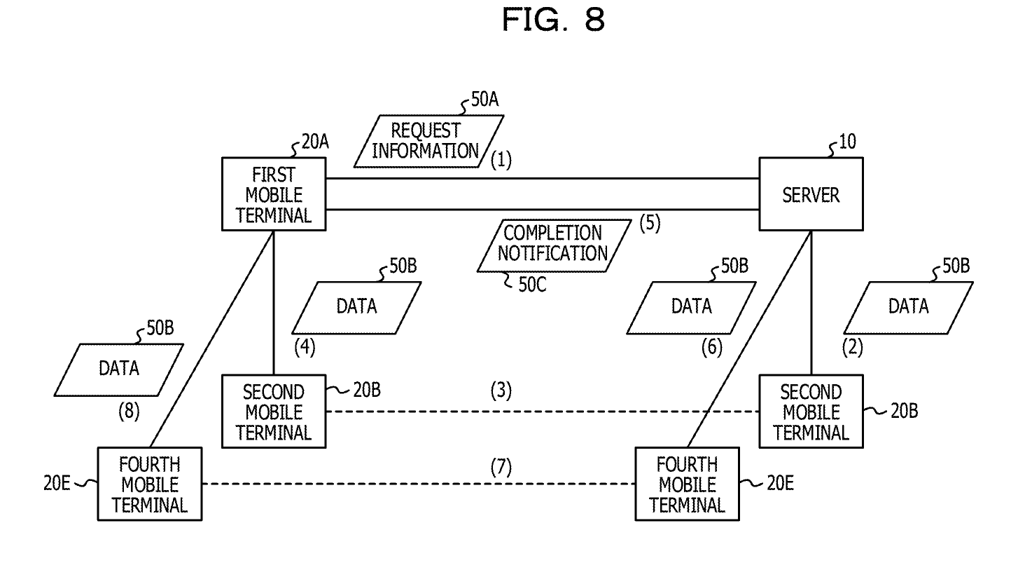

FIG. 8 is a conceptual diagram for explaining an example of data communication control according to the third embodiment. In the present embodiment, as illustrated in FIG. 8, processing (1) to (4) is similar to that in the first embodiment illustrated in FIG. 3. In the present embodiment, as indicated by a solid line (4), the first mobile terminal 20A receives the data 50B through ad-hoc communication from the second mobile terminal 20B. As indicated by a solid line (5), the first mobile terminal 20A transmits a completion notification 50C indicating receipt of the data 50B, to the server 10 through cellular telephone communication.

Having received the completion notification 50C, the server 10 completes the data communication control process; however, if the server 10 does not receive the completion notification 50C within a given period of time, the server 10 transmits the data 50B to the mobile terminal 20E, which is a fourth mobile terminal, through cellular telephone communication, as indicated by a solid line (6). Having received the data 50B, as indicated by a broken line (7), the mobile terminal 20E moves to an area where communication with the first mobile terminal 20A is possible through ad-hoc communication, and, as indicated by a solid line (8), the mobile terminal 20E transmits the data 50B to the first mobile terminal 20A through ad-hoc communication.

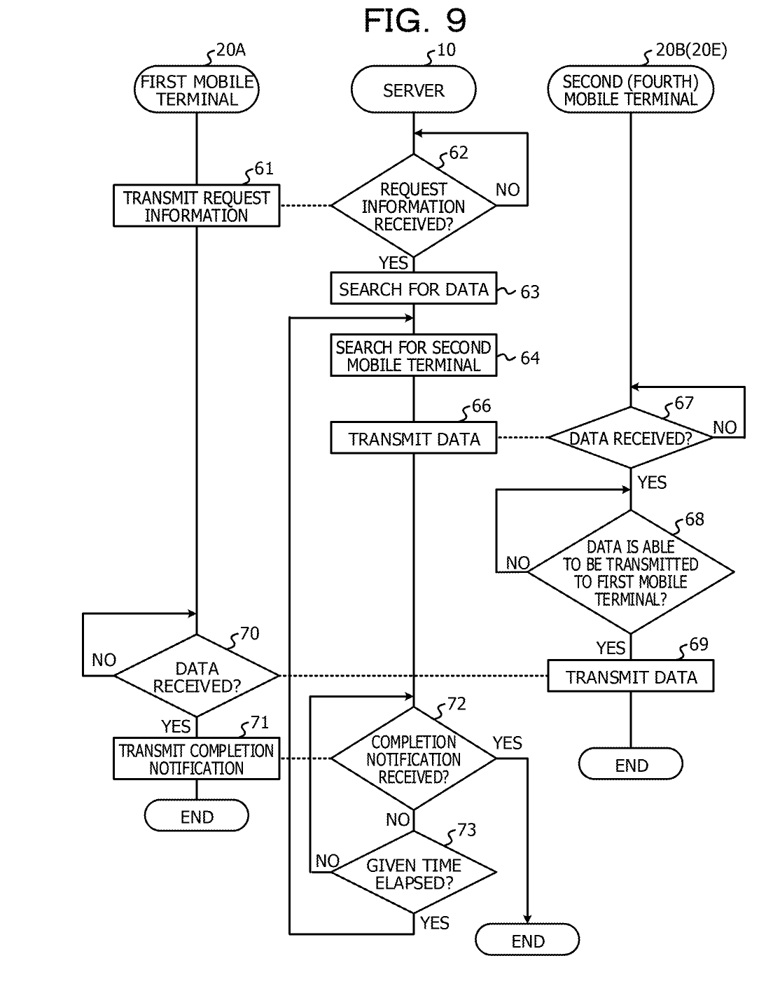

FIG. 9 is a flowchart illustrating an example of a flow of a data communication process according to the third embodiment. As illustrated in FIG. 9, if the determination in step 70 is affirmative, then, in step 71, the CPU 41A of the first mobile terminal 20A transmits the completion notification 50C to the server 10 via the communication unit 23A, and competes the data communication control process of the first mobile terminal 20A. The determination in step 70 is affirmative when the CPU 41A of the first mobile terminal 20A determines that the data 50B is received. The CPU 31 of the server 10 determines, in step 72, whether or not the completion notification 50C is received, and, if the determination is affirmative, completes the data communication control process of the server 10.

If the determination in step 72 is negative, then, in step 73, the CPU 31 determines whether or not a given period of time has elapsed after starting transmission of the data 50B in step 66. The given period of time may be the time obtained by multiplying the time T, which is the time taken for the data 50B to be transmitted to the first mobile terminal 20A, by a constant. The time T may, but does not necessarily have to, be acquired, for example, by T1+T2+T3 or T1+T2+T3+T4 as mentioned above.

If the determination in step 73 is negative, the CPU 31 returns to step 72. If the determination in step 73 is affirmative, that is, if the completion notification 50C is not received within the given period of time, the CPU 31 searches for the fourth mobile terminal in step 64. In this example, the mobile terminal 20E is searched for as the fourth mobile terminal (the mobile terminal 20E is hereinafter also called a fourth mobile terminal 20E). The condition for the fourth mobile terminal is similar to the condition for the second mobile terminal. In step 66, the CPU 31 transmits the data 50B, the location information of the first mobile terminal 20A, and an instruction for transferring the data 50B to the first mobile terminal 20A, to the fourth mobile terminal 20E via the communication unit 13, and proceeds to step 72.

In step 67, the CPU 41E of the fourth mobile terminal 20E determines whether or not the data 50B is received via the communication unit 23E, and repeats step 67 until an affirmative determination is obtained in step 67. If the determination in step 67 is affirmative, then, in step 68, the CPU 41E determines whether or not the data 50B is able to be transmitted to the first mobile terminal 20A via the ad-hoc communication unit 24E, and repeats step 68 until an affirmative determination is obtained. The determination in step 68 is affirmative when the fourth mobile terminal 20E has moved to an area where ad-hoc communication with the first mobile terminal 20A is possible.

If the determination in step 68 is affirmative, then, in step 69, the CPU 41E transmits the data 50B to the first mobile terminal 20A via the ad-hoc communication unit 24E, and completes the data communication control process of the fourth mobile terminal 20E.

In the present embodiment, the server 10 identifies the second mobile terminal 20B in response to the request information 50B from the first mobile terminal 20A, which is capable of performing cellular telephone communication and ad-hoc communication. The second mobile terminal 20B is a mobile terminal that is predicted to be located near the first mobile terminal 20A based on the location information of the mobile terminal 20, and is capable of performing cellular telephone communication and ad-hoc communication. The server 10 transmits the data 50B corresponding to the request information 50A to the second mobile terminal 20B through cellular telephone communication that allows communication with the second mobile terminal 20B to be performed at or above a given rate. Additionally, the server 10 instructs the second mobile terminal 20B that, when the second mobile terminal 20B receives the data 50B, the second mobile terminal 20B transfer the received data 50B to the first mobile terminal 20A through ad-hoc communication.

If, within the given period of time, the server 10 does not receive a completion notification from the first mobile terminal 20A indicating that the first mobile terminal 20A has received data, the server 10 identifies the fourth mobile terminal 20E. The fourth mobile terminal 20E is a mobile terminal that is predicted to be located near the first mobile terminal 20A based on the location information of the mobile terminal 20 and that is capable of performing cellular telephone communication and ad-hoc communication. The server 10 transmits the data 50B to the identified fourth mobile telephone 20E through cellular telephone communication that allows communication with the fourth mobile terminal 20E to be performed at or above the given rate. The server 10 instructs the fourth mobile terminal 20E that, when the fourth mobile terminal 20E receives the data 50B, the fourth mobile terminal 20E transfer the received data 50B to the first mobile terminal 20A through ad-hoc communication.

As described above, in the present embodiment, when communication between the server 10 and the first mobile terminal 20A has a decreased communication rate, data is efficiently transmitted from the server 10 to the first mobile terminal 20A. Additionally, if transmission of the data 50B to the first mobile terminal 20A fails, for example, because the second mobile terminal 20B moves differently from the prediction, the data 50B is automatically transmitted again to the first mobile terminal 20A by the fourth mobile terminal 20E. Accordingly, the possibility that the data 50B will not be transmitted to the first mobile terminal 20A is reduced.

### Fourth Embodiment

Next, a fourth embodiment, an example of the embodiments, will be described. The configurations and operations similar to those in the first embodiment, the second embodiment, or the third embodiment are not described herein. Note that the configuration of a mobile terminal 20F or a mobile terminal 20G is similar to that of the mobile terminal 20A, the mobile terminal 20C, or the mobile terminal 20D, and the reference numerals of components of the mobile terminal 20F and the mobile terminal 20G are accompanied with F and G, respectively, in place of A, C, or D.

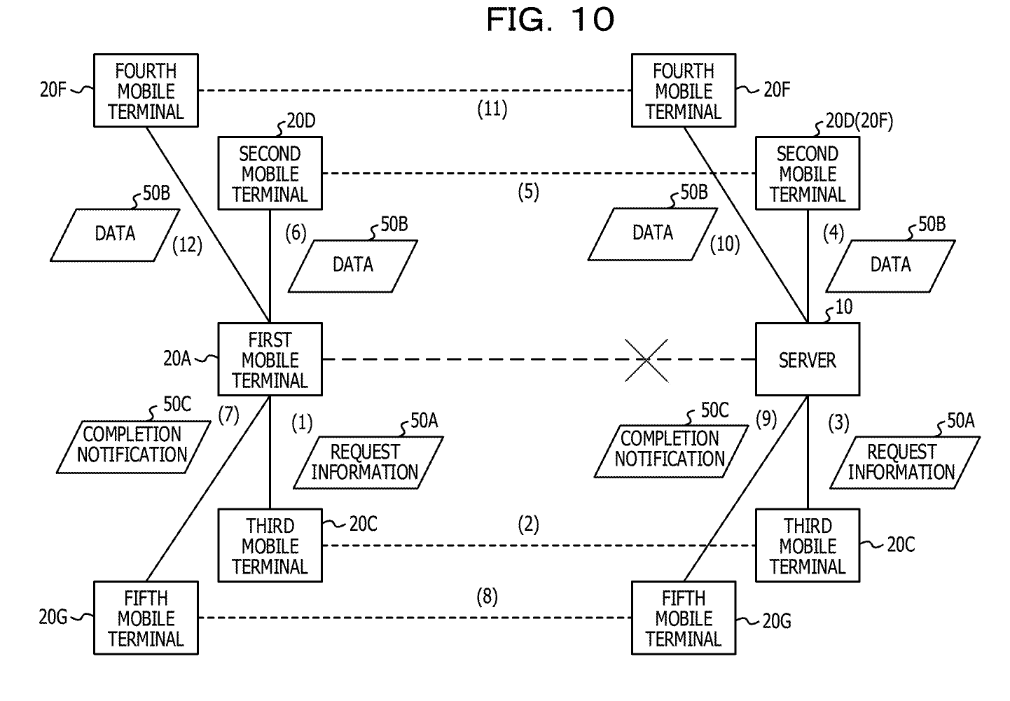

FIG. 10 is a conceptual diagram for explaining an example of data communication control according to the fourth embodiment. In the present embodiment, as illustrated in FIG. 10, processing (1) to (6) is similar to that in the second embodiment illustrated in FIG. 6. In the present embodiment, as indicated by a solid line (6), upon receiving the data 50B from the second mobile terminal 20D through ad-hoc communication, as indicated by a solid line (7), the first mobile terminal 20A transmits the completion notification 50C to the mobile terminal 20G, which is a fifth mobile terminal (the mobile terminal 20G is hereinafter also called a fifth mobile terminal 20G), through ad-hoc communication. The completion notification 50C indicates that the first mobile terminal 20A has received the data 50B.

As indicated by a broken line (8), upon moving into an area where communication with the server 10 is possible through cellular telephone communication, as indicated by a solid line (9), the fifth mobile terminal 20G transmits the completion notification 50C to the server 10 through the cellular telephone communication. Having received the completion notification 50C, the server 10 completes the process; however, if the server 10 does not receive the completion notification 50C within a given period of time, as indicated by a solid line (10), the server 10 transmits the data 50B to the mobile terminal 20F, which is the fourth mobile terminal (the mobile terminal 20F is hereinafter also called a fourth mobile terminal 20F), through cellular telephone communication.

As indicated by a broken line (11), upon moving into an area where communication with the first mobile terminal 20A is possible through ad-hoc communication, as indicated by a slid line (12), the mobile terminal 20F transmits the data 50B to the first mobile terminal 20A through ad-hoc communication.

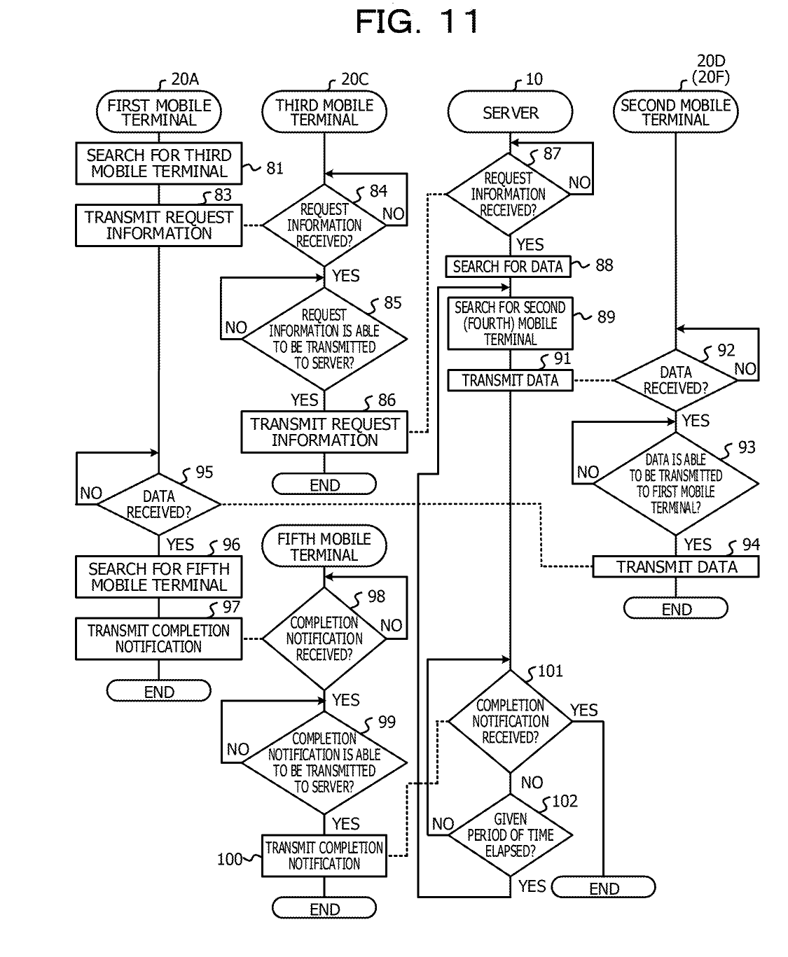

FIG. 11 is a flowchart illustrating an example of a flow of the data communication control process according to the fourth embodiment. As illustrated in FIG. 11, if the determination in step 95 is affirmative, that is, if the CPU 41A of the first mobile terminal 20A determines that the data 50B is received, then, in step 96, the CPU 41A searches for the fifth mobile terminal. The condition for the fifth mobile terminal is similar to the condition for the third mobile terminal. In this example, the mobile terminal 20G is searched for as the fifth mobile terminal.

In step 97, the CPU 41A transmits the completion notification 50C to the fifth mobile terminal 20G via the ad-hoc communication unit 24A and completes the data communication control process of the first mobile terminal 20A. In step 98, the CPU 41G of the fifth mobile terminal 20G determines whether or not the completion notification 50 is received via the ad-hoc communication unit 24G, and repeats step 98 until an affirmative determination is obtained.

If the determination in step 98 is affirmative, then, in step 99, the CPU 41G determines whether or not the completion notification 50C is able to be transmitted to the server 10, that is, whether or not the fifth mobile terminal 20G has moved into an area where communication with the server 10 is possible through cellular telephone communication. The CPU 41G repeats step 99 until an affirmative determination is obtained in step 99. If the determination in step 99 is affirmative, then, in step 100, the CPU 41G transmits the completion notification 50C to the server 10 via the communication unit 23G and completes the data communication control process of the fifth mobile terminal 20G.

In step 101, the CPU 31 of the server 10 determines whether or not the completion notification 50C is received via the communication unit 13, and, if the determination is affirmative, completes the data communication control process of the server 10. If the determination is negative, then, in step 102, the CPU 31 determines whether or not a given period of time has elapsed after starting transmission of data in step 91, and, if the determination is negative, retunes to step 101.

The given period of time may be the time obtained by multiplying the time T, which is the time taken for the data 50B to be transmitted to the first mobile terminal 20A, by a constant. The time T may, but does not necessarily have to, be acquired, for example, by T1+T2+T3 or T1+T2+T3+T4 as mentioned above.

If the determination in step 102 is affirmative, that is, if the completion notification 50C is not received within the given period of time, the CPU 31 returns to step 89 and searches for the fourth mobile terminal. In this example, the mobile terminal 20F is searched for as the fourth mobile terminal. In step 91, the CPU 31 transmits the data 50B to the mobile terminal 20F via the communication unit 13.

In step 92, the CPU 41 of the mobile terminal 20F determines whether or not the data 50B is received from the server 10 via the communication unit 23F, and repeats step 92 until an affirmative determination is obtained.

If the determination in step 92 is affirmative, then, in step 93, the CPU 41F determines whether or not the data 50B is able to be transmitted to the first mobile terminal 20A. That is, the CPU 41F determines whether or not the mobile terminal 20F has moved into an area where communication with the first mobile terminal 20A is possible through ad-hoc communication. Step 93 is repeated until an affirmative determination is obtained, and, if an affirmative determination is obtained, the CPU 41F transmits the data 50B to the first mobile terminal 20A via the ad-hoc communication unit 24F and completes the data communication control process of the fourth mobile terminal 20F.

In the present embodiment, the server 10 identifies the second mobile terminal 20D in response to the request information 50B from the first mobile terminal 20A that is capable of performing cellular telephone communication and ad-hoc communication. The second mobile terminal 20D is a mobile terminal that is predicted to be located near the first mobile terminal 20A based on the location information of the mobile terminal 20, and that is capable of performing cellular telephone communication and ad-hoc communication. The server 10 transmits the data 50B corresponding to the request information 50A to the second mobile terminal 20D through cellular telephone communication that allows communication with the second mobile terminal 20D to be performed at or above a given rate. Additionally, the server 10 instructs the second mobile terminal 20D that, when the second mobile terminal 20D receives the data 50B, the second mobile terminal 20D transfer the received data 50B to the first mobile terminal 20A through ad-hoc communication.

Additionally, the server 10 receives, through cellular telephone communication, the request information 50A received from the first mobile terminal 20A through ad-hoc communication by the third mobile terminal 20C that is capable of performing cellular telephone communication, through which communication with the server 10 is possible, and is capable of performing ad-hoc communication.

If, within the given period of time, the server 10 does not receive a completion notification from the first mobile terminal 20A indicating that the first mobile terminal 20A has received data, the server 10 identifies the fourth mobile terminal 20F. The fourth mobile terminal 20F is a mobile terminal that is predicted to be located near the first mobile terminal 20A based on the location information of the mobile terminal 20, and that is capable of performing cellular telephone communication and ad-hoc communication. The server 10 transmits the data 50B to the identified fourth mobile terminal 20F through cellular telephone communication that allows communication with the fourth mobile terminal 20F at or above the given rate. The server 10 instructs the fourth mobile terminal 20F that, when the fourth mobile terminal 20F receives the data 50B, the fourth mobile terminal 20F transfer the received data 50B to the first mobile terminal 20A through ad-hoc communication.

The server 10 receives, through cellular telephone communication, the completion notification received from the first mobile terminal through ad-hoc communication by the fifth mobile terminal that is capable of performing cellular telephone communication and ad-hoc communication.

Additionally, as described above, in the present embodiment, when direct communication between the server 10 and the first mobile terminal 20A is interrupted, data is efficiently transmitted from the server 10 to the first mobile terminal 20A. Additionally, in some cases, transmission of the data 50B to the first mobile terminal 20A fails, for example, because the second mobile terminal 20D or the third mobile terminal 20C moves differently from the prediction. In the present embodiment, if transmission of the data 50B to the first mobile terminal 20A fails, the data 50B is automatically transmitted again to the first mobile terminal 20A by the fourth mobile terminal 20F. Accordingly, the possibility that the data 50B will not be transmitted to the first mobile terminal 20A is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method executed by an information processing apparatus, the method comprising:
in response to a data transmission request from a first mobile terminal capable of performing first wireless communication and second wireless communication different from the first wireless communication, identifying a second mobile terminal that is predicted to be located near the first mobile terminal based on location management information, the second mobile terminal being capable of performing the second wireless communication and third wireless communication different from the first wireless communication;
transmitting data corresponding to the data transmission request to the identified second mobile terminal through the third wireless communication; and
instructing the second mobile terminal to, when the second mobile terminal receives the data, transfer the received data to the first mobile terminal through the second wireless communication.

2. The method according to claim 1, further comprising:
when communication through the first wireless communication between the information processing apparatus and the first mobile terminal is interrupted, receiving, from the third mobile terminal through the third wireless communication, the data transmission request received from the first mobile terminal through the second wireless communication by the third mobile terminal capable of performing the third wireless communication and the second wireless communication.

3. The method according to claim 1, further comprising:
when a completion notification from the first mobile terminal indicating that the first mobile terminal has received the data is not received within a given period of time, identifying a fourth mobile terminal that is predicted to be located near the first mobile terminal based on the location management information, the fourth mobile terminal being capable of performing the third wireless communication and the second wireless communication;
transmitting the data to the identified fourth mobile terminal through the third wireless communication; and
instructing the fourth mobile terminal to, when the fourth mobile terminal receives the data, transfer the received data to the first mobile terminal through the second wireless communication.

4. The method according to claim 3, further comprising:
receiving, from the fifth mobile terminal through the third wireless communication, the completion notification received from the first mobile terminal through the second wireless communication by a fifth mobile terminal capable of performing the third wireless communication and the second wireless communication.

5. The method according to claim 1, wherein
the data transmission request is transmitted from the first mobile terminal when a communication rate through the first wireless communication is lower than or equal to a given rate.

6. The method according to claim 1, wherein
the second wireless communication is short-distance wireless communication.

7. The method according to claim 1, wherein
a data size of the data transmission request is smaller than a data size of the data corresponding to the data transmission request.

8. An information processing apparatus comprising:
a memory; and
a processor coupled to the memory and configured to:
in response to a data transmission request from a first mobile terminal capable of performing first wireless communication and second wireless communication different from the first wireless communication, identify a second mobile terminal that is predicted to be located near the first mobile terminal based on location management information, the second mobile terminal being capable of performing the second wireless communication and third wireless communication different from the first wireless communication,
transmit data corresponding to the data transmission request to the identified second mobile terminal through the third wireless communication, and
instruct the second mobile terminal to, when the second mobile terminal receives the data, transfer the received data to the first mobile terminal through the second wireless communication.

9. The information processing apparatus according to claim 8, wherein the processor is configured to:
when communication through the first wireless communication between the information processing apparatus and the first mobile terminal is interrupted, receive, from the third mobile terminal through the third wireless communication, the data transmission request received from the first mobile terminal through the second wireless communication by the third mobile terminal capable of performing the third wireless communication and the second wireless communication.

10. The information processing apparatus according to claim 8, wherein the processor is configured to:
when a completion notification from the first mobile terminal indicating that the first mobile terminal has received the data is not received within a given period of time, identify a fourth mobile terminal that is predicted to be located near the first mobile terminal based on the location management information, the fourth mobile terminal being capable of performing the third wireless communication and the second wireless communication,
transmit the data to the identified fourth mobile terminal through the third wireless communication, and
instruct the fourth mobile terminal to, when the fourth mobile terminal receives the data, transfer the received data to the first mobile terminal through the second wireless communication.

11. The information processing apparatus according to claim 10, wherein the processor is configured to:
receive, from the fifth mobile terminal through the third wireless communication, the completion notification received from the first mobile terminal through the second wireless communication by a fifth mobile terminal capable of performing the third wireless communication and the second wireless communication.

12. The information processing apparatus according to claim 8, wherein
the data transmission request is transmitted from the first mobile terminal when a communication rate through the first wireless communication is lower than or equal to a given rate.

13. The information processing apparatus according to claim 8, wherein
the second wireless communication is short-distance wireless communication.

14. The information processing apparatus according to claim 8, wherein
a data size of the data transmission request is smaller than a data size of the data corresponding to the data transmission request.

15. A non-transitory storage medium storing a program for causing an information processing apparatus to execute a process, the process comprising:
in response to a data transmission request from a first mobile terminal capable of performing first wireless communication and second wireless communication different from the first wireless communication, identifying a second mobile terminal that is predicted to be located near the first mobile terminal based on location management information, the second mobile terminal being capable of performing the second wireless communication and third wireless communication different from the first wireless communication;
transmitting data corresponding to the data transmission request to the identified second mobile terminal through the third wireless communication; and
instructing the second mobile terminal to, when the second mobile terminal receives the data, transfer the received data to the first mobile terminal through the second wireless communication.

16. The non-transitory storage medium according to claim 15, wherein the process further comprises:
when communication through the first wireless communication between the information processing apparatus and the first mobile terminal is interrupted, receiving, from the third mobile terminal through the third wireless communication, the data transmission request received from the first mobile terminal through the second wireless communication by the third mobile terminal capable of performing the third wireless communication and the second wireless communication.

17. The non-transitory storage medium according to claim 15, wherein the process further comprises:
when a completion notification from the first mobile terminal indicating that the first mobile terminal has received the data is not received within a given period of time, identifying a fourth mobile terminal that is predicted to be located near the first mobile terminal based on the location management information, the fourth mobile terminal being capable of performing the third wireless communication and the second wireless communication;
transmitting the data to the identified fourth mobile terminal through the third wireless communication; and
instructing the fourth mobile terminal to, when the fourth mobile terminal receives the data, transfer the received data to the first mobile terminal through the second wireless communication.

18. The non-transitory storage medium according to claim 16, wherein the process further comprises:
receiving, from the fifth mobile terminal through the third wireless communication, the completion notification received from the first mobile terminal through the second wireless communication by a fifth mobile terminal capable of performing the third wireless communication and the second wireless communication.

19. The non-transitory storage medium according to claim 15, wherein
the data transmission request is transmitted from the first mobile terminal when a communication rate through the first wireless communication is lower than or equal to a given rate.

20. The non-transitory storage medium according to claim 15, wherein
the second wireless communication is short-distance wireless communication.
